(19) United States
(12) Patent Application Publication
(10) Pub. No.: US 2004/0013934 A1
(43) Pub. Date: Jan. 22, 2004

(54) Platinum-free fuel cell

(76) Inventor: Birger H. Olson, Northport, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/200,366

(22) Filed: Jul. 22, 2002

(51) Int. Cl. H01M 4/86; H01M 8/10

(52) U.S. Cl. 429/42; 429/44; 429/30

(57) ABSTRACT

A platinum-free fuel cell is disclosed, having an ion exchange resin in the electrodes of the fuel cell. The ion exchange resin electrodes can be used in a proton exchange membrane (PEM), alkaline or phosphoric acid or fuel cells by replacing the traditional platinum catalyst electrodes.

### BACKGROUND OF THE INVENTION

The present invention generally relates to electrochemical cells. More specifically, the present invention relates to catalysts and electrodes of fuel cells.

Electrochemical cells which employ proton exchange membranes and electrodes, in which catalytically active electrically-conductive materials are included, are well known in the art. Such cells can be used for the generation of electricity in, for example, fuel cells.

Fuel cells convert a fuel, physically separated from an oxidizing agent, into electricity at two electrodes. Hydrogen-rich gas can be used as the fuel and oxygen or air as the oxidizing agent. The energy conversion process results in electricity, heat and water.

Fuel cells typically consist of a polymer electrolyte membrane, or proton exchange membrane, which is provided on both sides with catalyst electrodes. The polymer electrolyte membrane consists of proton-conducting polymer materials. One of the electrodes acts as an anode for the oxidation of hydrogen and the second electrode acts as a cathode for the reduction of oxygen. The two electrodes in the assembly, the anode and cathode, contain so-called electrocatalysts which catalytically support the respective reaction (oxidation of hydrogen at the anode or reduction of oxygen at the cathode).

The metals of the platinum group of the Periodic Table of Elements are typically used as the catalytically active components in the electrodes. The cost of fuel cells is largely attributed to the platinum group metals that were required for the catalytic material in the anode and cathode. The cost of the platinum catalyst and the ease of their poisoning which in turn requires replacement, has slowed the widespread use of fuel cells, including introduction of fuel cells as replacement to the combustion engine.

Attempts have been made to reduce the costs per kilowatt of installed capacity by reducing the amount of platinum group metals loaded into the electrodes of a fuel cell. However, while attempts have been made to reduce the amount of platinum group metals used in the catalytic layers of fuel cells, the elimination of platinum group metals, while maintaining the efficiency of the fuel cells, is yet to be resolved.

### SUMMARY OF THE INVENTION

It is an aspect of the present invention to provide a fuel cell having electrodes that are free of platinum group metals. To achieve this and other aspects and advantages, the fuel cell according to the present invention comprises ion exchange resin catalyst electrodes that can be used in a proton exchange membrane (PEM), alkaline or phosphoric acid fuel cells, and electrochemical reactors.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is a partial cross-section of a fuel cell embodying the present invention.

FIG. 2 is a top view of an assembled fuel cell of the present invention.

FIG. 3 is a cross section of an assembled fuel cell of the present invention, taken along lines III-III of FIG. 2.

### DETAILED DESCRIPTION OF THE PREFERRED EMBODIMENT

The cation and/or anion exchange catalyst electrode construction in accordance with the present invention can be used in proton exchange membrane (PEM), alkaline, or phosphoric acid fuel cells and electrochemical reactors.

The PEM fuel cell 18 constructed in accordance with the disclosed embodiment, and as discussed below as test fuel cell A, comprises a cathode 16, an anode 14 and a proton exchange membrane electrolyte 20. The fuel cell 18 may have essentially any construction. For example, the electrodes may have a bobbin-type, spiral-wound (i.e., jelly roll), stacked or any other construction.

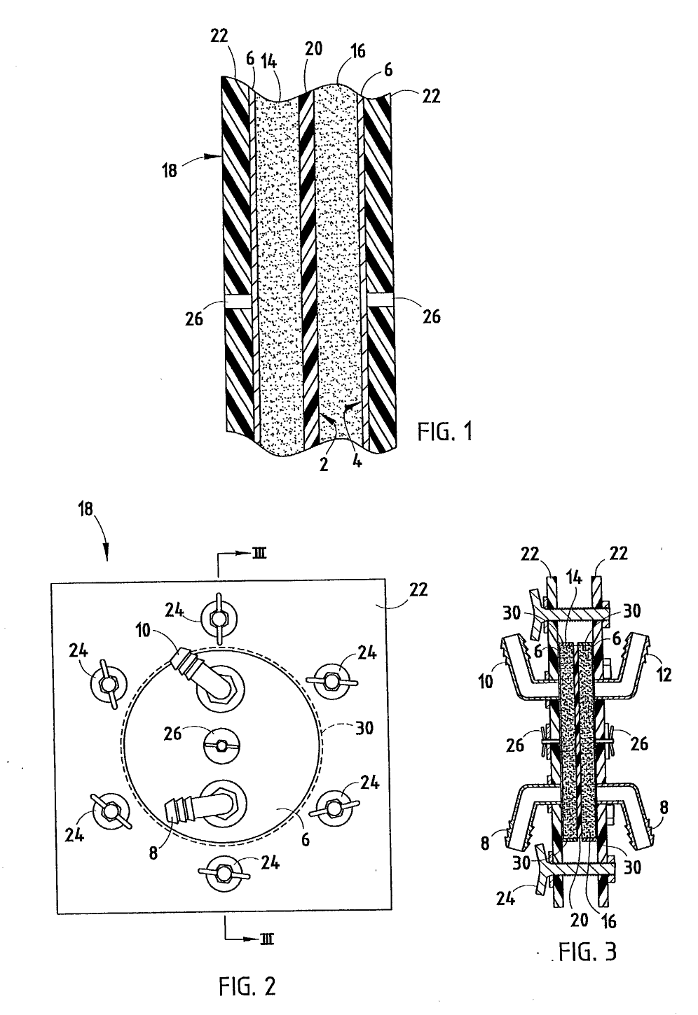

FIGS. 1, 2 and 3 serve to clarify the terms used in this invention. FIG. 1 shows a cross section of a portion of fuel cell 18. The ion exchange resin catalyst electrodes include a proton exchange membrane electrolyte side 2 and a current collector and gas diffuser side 4. FIG. 1 also illustrates the combined current collector and gas diffuser 6 which interfaces with the current collector side 4 of each ion exchange resin catalyst electrode.

The fuel cell 18 includes a proton exchange membrane electrolyte 20 and two identical porous ion exchange resin catalyst electrodes (14, 16) placed on either side of the proton exchange membrane electrolyte 20. The porous catalyst layer of the electrodes should have good contact with the proton exchange membrane electrolyte 20 and with the corresponding stainless steel collector and gas diffuser 6. The fuel cell 18 is positioned and sealed between two end plates 22. The steel current collector transmits the electric current through an insulated stainless steel conductor 26 that passes through the end plates 22. The hydrogen fuel is introduced by a hydrogen inlet 10 in one of the end plates 22 and through the gas diffuser 6 and throughout the porous catalyst layer (FIG. 3). The hydrogen fueled electrode becomes the anode 14 of the fuel cell 18. The other electrode receives oxygen or air in a like manner through the oxygen inlet 12 and becomes the cathode 16. Exhaust outlets 8 are positioned on each side of the fuel cell 18.

The porous catalyst electrodes (14,16) are made in an identical manner in the disclosed embodiment. However, the cathode 16 and the anode 14 may be made in different manners and with different ion exchange resins. In the disclosed embodiment, three parts by volume of the hydrogen form of the ion exchange resins are mixed with one part, by volume, of powdered charcoal. Clean fine stainless steel is placed in contact with the stainless steel current collector and enough of it is used for the stainless steel wool to pick up the current throughout the charcoal and ion exchange resin catalyst layer. The thin layer of ion exchange resin and a charcoal mix is spread on the side of the stainless steel wool that will be adjacent to the proton exchange membrane electrolyte 20. This layer should be approximately 2 millimeters thick. The mixture of charcoal, stainless steel wool and ion exchange resin may be moistened with water to help form the ion exchange catalyst layer.

FIG. 3 illustrates a cross section of the fuel cell 18. The hydrogen inlet 10 and exhaust outlet 8 are present on the anode 14 side of the fuel cell 18. The oxygen inlet 12 and exhaust outlet 8 are present on the cathode 16 side of the fuel cell 18. A PVC pipe 30 is used to hold the material that comprises the anode 14 and the cathode 16. FIG. 2 illustrates the anode side 14 of fuel cell 18. The end plates 22 are secured by fasteners 24.

The catalyst portion of each electrode is comprised of one or more ion exchange resins that act as a catalyst. The catalyst portion of each electrode may be sealed to the proton exchange membrane electrolyte 20 as long as the sealant passes the maximum current and allows the fuel (hydrogen, for example) to diffuse through the catalyst layer.

The proton exchange membrane electrolyte 20 may be of any material known to one of ordinary skill in the art. Typically, these membranes consist of proton-conducting polymer materials, also referred as ionomers. However, in the present invention, the proton exchange membrane is preferably Nafion® manufactured by E. I. du Pont Company. Other proton-conducting materials that do not conduct electrons may be used.

Ion exchange resins may be used for both the catalytic portion of the anode and cathode. These ion exchange resins should act as suitable catalysts. Such ion exchange resins are commercially available, including Amberlite®, Dowex® and Ionac® brand exchange resins available from Rohm & Haas, The DOW Chemical Company, and Sybron, respectively.

Some cation exchange resins that exhibit suitable catalytic activity have a sulfonic acid functional group as the ion exchange site. More specifically, the test cells utilized Amberlite® 112-120, Dowex® 50, and Inonac® 249 brand cation exchange resins. These resins may be mixed.

Some anion exchange resins that exhibit suitable catalytic activity have a trimethylbenzylammonium functional group as the ion exchange site. The test fuel cells utilized Amberlite® IRA-400 anion exchange resin in hydroxyl form.

Many ion exchange resins not listed above may be added or substituted for the ion exchange resins in either of the catalyst electrodes.

Having generally described the preferred structure of the present invention, comparative examples are described below to demonstrate the replacement of the very expensive platinum and platinum group catalysts by much less costly ion exchange resin catalysts of the inventive fuel cells. The specific examples described below are provided for purposes of illustration only and are not intended to limit the scope of invention as set forth in the claims.

Test Fuel Cell A

Test fuel cell A was constructed to test ion exchange resin catalysts. The end plates were made of 0.5″ thick Plexiglass. Housed within the end plates was a stainless steel current collector and gas diffuser, 2⅞″ in diameter, fastened to the end of each plate. The fastener used to connect the Plexiglass end plates and the stainless steel current collector were ¼″ stainless steel bolts with gasket and washers to prevent leakage. Each end plate contains two hose connections fastened by ¼″ pipe threads. Next to each end plate is a catalytic unit made up of a 3/16″ thick ring of 3″ diameter PVC pipe. Placed in the PVC pipe section is a fine grade stainless steel wool which makes contact with the steel current collector. A mixture of charcoal and cationic exchange resin, in the hydrogen form, is placed in the PVC pipe section with the fine grade stainless steel wool. The charcoal is present to aid in the transfer of current from the resin to the fine grade stainless steel wool. The ratio of charcoal to resin is not critical, however, one part of charcoal to three parts of resin was used in this example. The proton exchange membrane electrolyte, which was made of Nafion,® was placed between the two catalyst electrodes to complete the fuel cell. Both catalyst electrodes were made in the same manner in the illustrated example of Test Fuel Cell A. However, the anode and cathode may be made in different manners, including the use of different ion exchange resins.

The output of the fuel cell was measured using an LCD Auto Range Digital Multimeter, with the range and accuracy as follows:

| | |
|---|---|
| DC Volts | ±0.8% of reading and 0.2% of full scale and |
| 400 mV; 4 V; 1000 V | 1 in last digit |
| AC Volts | ±1% of reading 0.5% of full scale and 3 in |
| 4 V; 40 V; 750 V | last digit |
| DC Current | ±1.5% of reading and ±0.2% of full scale |
| 40 mA; 400 mA; 10 A | |

Test Fuel Cell B

Test fuel cell B is a commercially sold Proton Exchange Membrane Fuel Cell (PEMFC) from h-tec and comes with two platinum catalyst electrodes. Test fuel cell B is used to give comparative voltages and comparative current to the same fuel cell with the ion exchange resin catalyst electrodes in which the catalyst used was approximately one millimeter thick and included the stainless steel collectors and diffusers.

Test Fuel Cell C

Test fuel cell C was a modified h-tec fuel cell wherein the platinum electrodes were replaced with similarly sized cation exchange resin electrodes.

Test Fuel Cell D

Test fuel cell D was constructed using a 250 mL beaker to hold the electrolyte (KOH 1 M), a stainless steel current collector, ion exchange resin catalyst, charcoal and sodium borohydride (to provide hydrogen). An electrical lead extends from the stainless steel current collector to the volt-ammeter. The other half of the fuel cell is a short section of 1½″ PVC pipe to which a circle of a proton exchange membrane (PEM) has been sealed across one end. It contains ion exchange resin and charcoal that is dampened with distilled water and also has a stainless steel current collector. The stainless steel current collector is connected to the volt-ammeter via another electrical lead. This is the oxygen half of the cell. Air was used as the oxygen source. The PEM was 0.78 sq. in. (3.88 sq. cm) in area as were the perforated similar sized stainless steel current collectors to which the ion exchange resin catalyst was in contact.

Operation of Fuel Cells

The fuel cells received a source of hydrogen and a source of oxygen. The oxygen connection can be pure oxygen or air. The LCD Auto Range Digital Multimeter is connected between the anode and the cathode built in series with a load resistor generally of about 1-2 ohms. Readings were taken of the voltage and current at various intervals, including one which was a reading of the current at maximum voltage and one which is a reading of the maximum draw of current and the associated voltage. The hydrogen used should be free of oxygen and the oxygen should be free of hydrogen, or the readings are reduced proportionately to the percent of contaminating gas.

Test fuel cell D was used to show the effect of temperature on the output of the fuel cell. Table 1 below shows a marked increase in the current output with the increase in temperature. There is also an increase in the maximum load voltage with an increase in temperature.

TABLE 1

| Temperature in | Max. | Max. Cur. | Max. Load | Max. Load |
|---|---|---|---|---|
| Degrees C. | Voltage | (mA) | Voltage | Cur. (mA) |
| 30 | 1.206 | 13.30 | .170 | 2.50 |
| 40 | 1.206 | 17.21 | .185 | 3.40 |
| 45 | 1.206 | 21.87 | .184 | 3.80 |
| 55 | 1.206 | 24.00 | .197 | 4.02 |

A direct comparison of the commercial platinum catalysts, test fuel cell B, with the ion exchange resin catalysts, test fuel cell C, is shown in Table 2. Per unit area, test fuel cell C yielded a higher voltage and higher output of current than the platinum catalyst fuel cell.

TABLE 2

| | | Cation Exch. Resin Catalyzed | |
|---|---|---|---|
| Platinum Catalyzed Cell 2.25 | | Cell 2.25 sq. in. Surface Area of | |
| sq. in Surface Area of PEM | | PEM | |
| Time in | Cell Output in | Time in | Cell Output in |
| Minutes | Millivolts | Minutes | Millivolts |
| 0 | 317 | 0 | 375 |
| 1 | 643 | 1 | 957 |
| 2 | 694 | 2 | 1018 |
| 3 | 718 | 3 | 1049 |
| 4 | 731 | 4 | 1070 |
| 5 | 739 | 5 | 1087 |
| 6 | 745 | 6 | 1098 |
| 7 | 751 | 7 | 1106 |
| 8 | 756 | 8 | 1115 |
| 9 | 761 | 9 | 1120 |
| 10 | 766 | 10 | 1126 |
| 15 | 781 | 15 | 1144 |
| 20 | 794 | 20 | 1147 |
| 30 | 804 | 30 | 1147 |
| 40 | 804 | 40 | 1198 |
| 50 | 805 | 50 | 1148 |
| 60 | 804 | 60 | 1147 |

In order to test whether the current output of the test fuel cell could be increased, the ion exchange resin catalyst was modified to contain 20% by volume of the cation exchange resin in copper form. The copper form of the resin was prepared by converting the hydrogen form of the resin to the copper form by stirring the hydrogen resin in an excess of saturated copper sulfate water solution. The catalyst electrode contained three parts cation exchange resin of which 80% was in the hydrogen form and 20% was in the copper form. The catalyst electrode also contained one part powdered charcoal. The copper form of the resin, when used in the ion exchange resin electrodes, improves the current output of the cell.

The modified test fuel cell C was run at room temperature, 28° C., with hydrogen as a fuel gas and air used to supply oxygen. The voltage and current readings were taken as follows:

TABLE 3

| Voltage (in Volts) | Current in Amps | Comment |
|---|---|---|
| 0.298 | 0.037 | |
| 0.452 | 0.063 | stable > 10 minutes |
| 0.637 | 0.073 | |
| 0.700 | 0.084 | |
| 0.749 | 0.089 | |
| 0.775 | 0.101 | |

The temperature at which the fuel cell is operated can be increased up to 150° C. The current produced by the fuel cell will continue to increase as the temperature increases. When the temperature is raised from 30° C. to 55° C., the current increased 1.8 times. The cation exchange resin shows no significant degradation of the resin below 150° C.

While the above invention has been described as fuel cells utilizing an ion exchange resin in both electrodes, benefits may be nevertheless attained by using the ion exchange resin in only one of the electrodes. Also, although the use of ion exchange resins in place of platinum group metals is the most preferable implementation of the present invention, some levels of platinum group metals may be used in combination with the inventive use of ion exchange resins.

The above description is considered that of the preferred embodiment only. Modification of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

The invention claimed is:

1. An electrode containing a catalyst layer comprising a catalytic cation exchange resin.

2. The electrode according to claim 1, wherein the cathode contains a current conductor.

3. The electrode according to claim 2, wherein the current conductor comprises carbon and fine stainless steel wool.

4. The electrode according to claim 1, wherein the cation exchange resin contains a sulfonic acid functional group.

5. The electrode according to claim 1, wherein the cation exchange resin is modified to a copper form.

6. An electrode containing a catalyst layer comprising a catalytic anion exchange resin.

7. The electrode according to claim 6, wherein the cathode contains a current conductor.

8. The electrode according to claim 7, wherein the current conductor comprises carbon and fine stainless steel wool.

9. The electrode according to claim 6, wherein the anion exchange resin contains a trimethylbenzylammonium functional group.

10. A fuel cell comprising:
an electrode containing a catalyst layer comprising a catalytic cation exchange resin; and
a proton exchange membrane.

11. The fuel cell of claim 10 further comprising a second electrode containing a catalyst layer comprising a catalytic cation exchange resin.

12. The fuel cell of claim 10 further comprising a second electrode containing a catalyst layer comprising a catalytic anion exchange resin.

13. A fuel cell comprising:
electrodes containing less than 50 parts of platinum group metals per million by weight of the cell; and
electrodes containing catalytic ion exchange resins.
